(19) United States
(12) Patent Application Publication
(10) Pub. No.: US 2024/0151020 A1
(43) Pub. Date: May 9, 2024

(54) FOLDABLE NOZZLE ASSEMBLY AND BIDET

(71) Applicant: Xiamen Nete Sanitary Co., Ltd., Xiamen (CN)

(72) Inventors: Xiaomin LUO, Xiamen (CN); Shaojie SHI, Xiamen (CN); Cheng YANG, Xiamen (CN); Weihao ZHENG, Xiamen (CN)

(21) Appl. No.: 18/502,060

(22) Filed: Nov. 5, 2023

(30) Foreign Application Priority Data
Nov. 9, 2022 (CN) 202222977555.4

(51) Int. Cl. E03D 9/08; B05B 15/70

(52) U.S. Cl. CPC E03D 9/08; B05B 15/70

(57) ABSTRACT

A foldable nozzle assembly and a bidet are provided. The foldable nozzle assembly includes a nozzle body. The nozzle body is equipped with a nozzle base, and a limiting component is installed between the nozzle base and the nozzle body. A rotational component on the nozzle base allows for the pivotal attachment of a rotating base, which supports a nozzle. The nozzle can be folded onto the nozzle base using the limiting component and the rotational component, enabling the foldable functionality of the bidet nozzle, reducing space occupation, and facilitating storage. The invention features a simple structure, ease of use, and practicality.

### FIELD OF THE INVENTION

The present invention relates to the field of bathroom technology, specifically to a foldable nozzle assembly and bidet.

### BACKGROUND OF THE INVENTION

A bidet is a device designed to flush the lower part of the human body after defecation and can also serve as a toilet seat, compatible with toilet bowls. With increasing attention to hygiene and health, more and more households are installing bidet. However, conventional bidet, due to their non-collapsible nozzles, occupy significant space and are inconvenient for storage. Consequently, the development of a compact, foldable nozzle bidet represents a pressing technical challenge.

### SUMMARY OF THE INVENTION

The object of the present invention is to address at least one of the technical issues present in the existing art by providing a foldable nozzle assembly and bidet.

In order to achieve the aforementioned object, the technical solution employed in the present invention is as follows: a foldable nozzle assembly includes a nozzle body, with a nozzle base mounted on the nozzle body. A limiting component is installed between the nozzle base and the nozzle body. A rotating base is mounted on the nozzle base through a rotational component, with a nozzle attached to the rotating base. The nozzle can be folded on the nozzle base using the limiting component and the rotational component.

In some embodiments, the limiting component includes limiting ribs and limiting orifices corresponding to the limiting ribs, with the limiting ribs being placed on the nozzle body, and the limiting orifices located on the nozzle base.

In some embodiments, the rotational component includes a rotating shaft and connecting tabs matching the rotating shaft. The rotating shaft is positioned on the nozzle base, while the connecting tabs are positioned on the rotating base.

In some embodiments, the nozzle includes spray holes and a nozzle rear cover, with the spray holes arranged opposite the nozzle rear cover.

In some embodiments, a spring is installed on the nozzle to facilitate the nozzle's reset.

In some embodiments, the nozzle body is equipped with guide holes to facilitate the nozzle's movement.

In some embodiments, the nozzle body is secured to the rotating base.

In some embodiments, at the water outlet of the nozzle base, a first sealing ring is arranged, with the rotating base sealingly connected to the nozzle base through the first sealing ring.

In some embodiments, at the water outlet of the rotating base, a second sealing ring is arranged, with the nozzle sealingly connected to the rotating base through the second sealing ring.

A bidet, including a bidet body, is also provided in the present invention. The foldable nozzle assembly described above is mounted on the bidet body and can be folded onto the bidet body.

The advantages of the present invention are as follows: As can be discerned from the description of the present invention, in comparison to the existing technology, a foldable nozzle assembly is provided, comprising a nozzle body with a nozzle base installed thereon. A limiting component is positioned between the nozzle base and the nozzle body. A rotating base is mounted on the nozzle base through a rotational component, with a nozzle attached to the rotating base. The nozzle can be folded onto the nozzle base through the use of the limiting component and the rotational component, thereby achieving the functionality of folding the bidet nozzle. This reduces space occupancy and facilitates storage. The structure of the present invention is straightforward, user-friendly, and exhibits practical robustness.

### BRIEF DESCRIPTION OF THE DRAWINGS

FIG. 1 shows an exploded view of the foldable nozzle assembly according to one embodiment in the present invention.

FIG. 2 shows a schematic diagram of the foldable nozzle assembly according to one embodiment in the present invention.

FIG. 3 shows a schematic diagram of the foldable nozzle assembly according to one embodiment in the present invention.

FIG. 4 shows a sectional view of the foldable nozzle assembly without water flow according to one embodiment in the present invention.

FIG. 5 shows a sectional view of the foldable nozzle assembly with water flow according to one embodiment in the present invention.

FIG. 6 shows a front view of the bidet according to one embodiment in the present invention.

FIG. 7 shows a rear view of the bidet according to one embodiment in the present invention.

### REFERENCE CHARACTERS IN THE DRAWINGS

1, Bidet body; 10, Nozzle assembly; 101, Nozzle body; 101A, Limiting rib; 102, Spring; 103, Nozzle rear cover; 104, Nozzle; 104A, Spray hole; 105, Second sealing ring; 106, Rotating base; 107, First sealing ring; 108, Nozzle base; 108A, Rotating shaft; 108B, Limiting orifices.

### DETAILED DESCRIPTION OF THE INVENTION

The following, in conjunction with the drawings according to embodiments of the present invention, provides a clear and comprehensive description of the technical solution within the present invention. It is evident that the described embodiments are merely a portion of the possible implementations of the present invention, rather than all of them.

In the description of the present invention, it is worth noting that, unless otherwise explicitly specified and limited, terms like “connected” and “joined” should be broadly construed. For instance, they can indicate a fixed connection or a detachable one, or they can signify a mechanical or electrical connection. These terms may denote direct connection or indirect connection through an intermediary, which is understood in specific contexts by those skilled in the art.

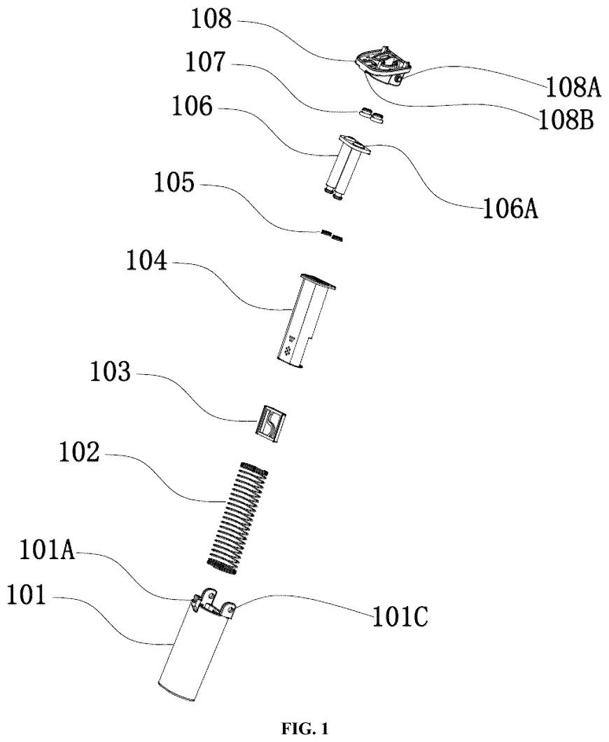

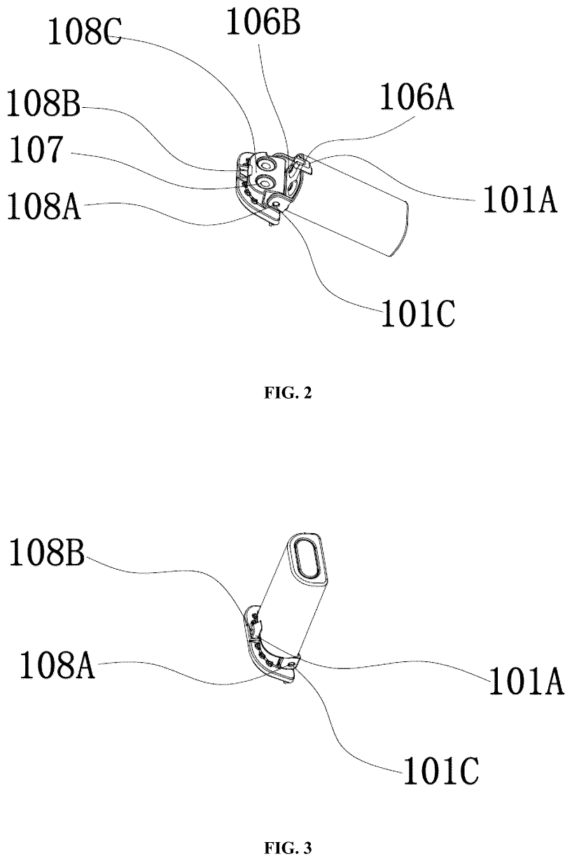

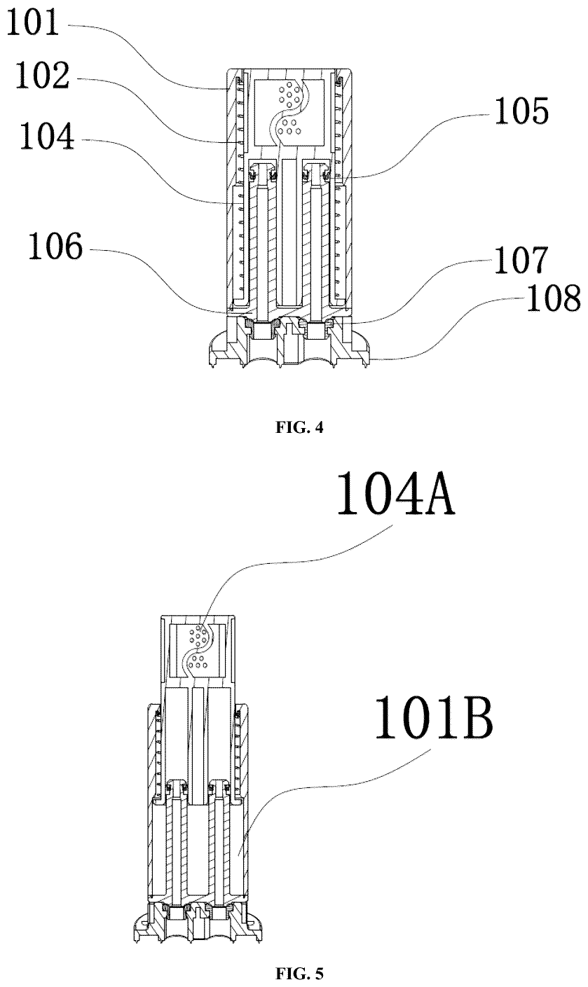

Referring to FIGS. 1 to 5, in one embodiment of the present invention, a foldable nozzle assembly is disclosed. The foldable nozzle assembly includes a nozzle body 101, with a nozzle base 108 mounted on the nozzle body 101. A limiting component is positioned between the nozzle base 108 and the nozzle body 101. The nozzle base 108, through a rotational component, holds a rotating base 106, and a nozzle 104 is attached to the rotating base 106. The nozzle 104 can be folded onto the nozzle base 108 through the use of the limiting component and the rotational component, thus realizing the foldable functionality of the bidet nozzle. This design reduces space occupation and facilitates storage. The structure of the present invention is straightforward, user-friendly, and exhibits practical robustness.

In some embodiments, the limiting component includes limiting ribs 101A and limiting orifices 108B matching the limiting ribs 101A, with the limiting ribs 101A located on the nozzle body 101. The limiting orifices 108B are positioned on the nozzle base 108, facilitating the separable or fixed connection between the nozzle and the nozzle base 108, which is beneficial for nozzle folding operations.

In this embodiment, the nozzle base 108 further includes a rotating shaft 108A. Connecting tabs 101C on the nozzle body 101 are engaged with the rotating shaft 108A, allowing the nozzle body 101 to rotate around the rotating shaft 108A relative to the nozzle base 108 in one direction. As seen in FIG. 1, the connecting tabs 101C are protrusions in the form of ear-like structures extending from the top edge of the nozzle body 101 and are positioned opposite each other. Similarly, the rotating shaft 108A is also positioned opposite the nozzle base 108, enabling the connecting tabs 101C to fit with the rotating shaft 108A. This enables the rotating base 106 to flip along the rotational shaft 108A to align its mating surface with the mating surface of the nozzle base 108, securing it through the nozzle body's limiting ribs 101A and the limiting orifices 108B of the nozzle base 108.

The nozzle 104 is equipped with spray holes 104A and a nozzle rear cover 103, with the spray holes 104A aligned opposite the nozzle rear cover 103. This configuration allows water to enter the rotating base 106 from the nozzle base 108 and subsequently enter the nozzle 104, where it propels the nozzle 104 to extend along the nozzle body's guiding hole 101B. Water then sprays out through the nozzle's spray holes 104A, achieving the flushing function.

A spring 102 is mounted on the nozzle 104 for resetting the nozzle 104. The nozzle body 101 is equipped with guiding holes 101B for nozzle 104 movement. Thus, when water flow is closed, the spring 102 causes the nozzle 104 to retract along the guiding holes 101B of the nozzle body 101.

The nozzle body 101 is secured to the rotating base 106, providing a sealed design for the nozzle and preventing water leakage.

At the water outlet of the nozzle base 108, there is a first sealing ring 107 installed. The rotating base 106 is sealingly connected to the nozzle base 108 through the first sealing ring 107. This is achieved through the sealing face 106B of the rotating base 106 mating with the sealing ring 107.

At the water outlet of the rotating base 106, there is a second sealing ring 105. The nozzle 104 is sealingly connected to the rotating base 106 through the second sealing ring 105, ensuring a seal between the nozzle 104 and the rotating base 106.

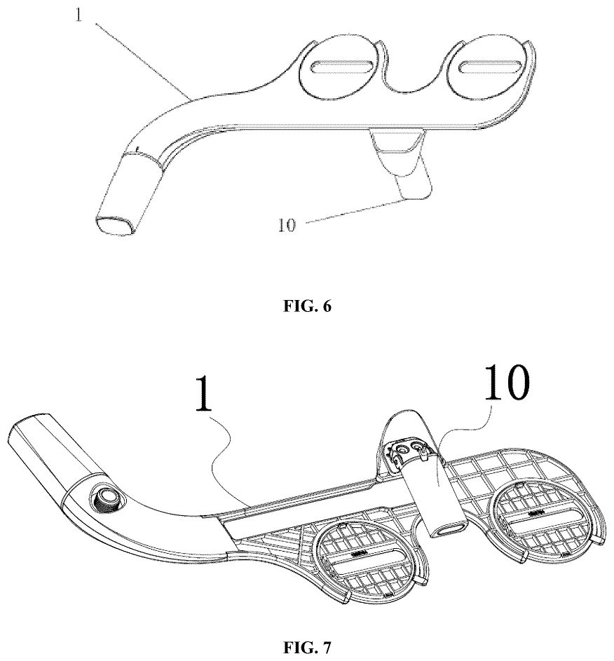

As shown in FIGS. 6 and 7, a bidet, including a bidet body 1, is provided. The foldable nozzle assembly 10, as described above, is mounted on the bidet body 1 and can be folded onto the bidet body 1.

Specifically, the rotational base 106 is rotated about the rotating shaft 108A of the nozzle base 108 through the connecting tabs 101C of the nozzle body 101. This causes the rotational base 106 to align its mating surface 106B with the mating surface 108C of the nozzle base 108. It is secured through the limiting ribs 101A of the nozzle body 101 and the limiting ribs 108B of the nozzle base 108. The sealing face 106A of the rotational base 106 cooperates with the sealing ring 107 to ensure sealing.

Conversely, releasing the cooperation between the limiting ribs 101A of the nozzle body 101 and the limiting orifices 108B of the nozzle base 108 allows the foldable nozzle to be folded.

In the absence of conflicts, those skilled in the art can freely combine and overlay the additional technical features mentioned above.

It is understood that the present invention has been described through certain embodiments, and those skilled in the art, without departing from the spirit and scope of the present invention, can make various changes or equivalent substitutions to these features and embodiments. Additionally, under the guidance of the present invention, these features and embodiments can be modified to suit specific circumstances and materials while still remaining within the spirit and scope of the present invention. Therefore, the present invention is not limited to the specific embodiments disclosed here, and all embodiments falling within the scope of the claims in this application are protected by the present invention.

What is claimed is:

1. A foldable nozzle assembly, comprising a nozzle body, wherein a nozzle base is mounted on the nozzle body, and a limiting component is installed between the nozzle base and the nozzle body; a rotational component on the nozzle base is configured to pivotally attach a rotating base, which in turn supports a nozzle; the nozzle is foldable onto the nozzle base using the limiting component and the rotational component.

2. The foldable nozzle assembly according to claim 1, wherein the limiting component comprises limiting ribs and matching limiting orifices, with the limiting ribs located on the nozzle body, and the limiting orifices positioned on the nozzle base.

3. The foldable nozzle assembly according to claim 1, wherein the rotational component comprises a rotating shaft and connecting tabs matched to the rotating shaft; the rotating shaft is positioned on the nozzle base, and the connecting tabs are positioned on the nozzle body.

4. The foldable nozzle assembly according to claim 1, wherein the nozzle comprises spray holes and a nozzle rear cover, with the spray holes arranged opposite the nozzle rear cover.

5. The foldable nozzle assembly according to claim 1, wherein a spring is installed on the nozzle to facilitate nozzle reset.

6. The foldable nozzle assembly according to claim 1, wherein the nozzle body is equipped with guiding holes for nozzle movement.

7. The foldable nozzle assembly according to claim 1, wherein the nozzle body is rotatably attached to the rotating base.

8. The foldable nozzle assembly according to claim 1, wherein a first sealing ring is positioned at the water outlet of the nozzle base, and the rotating base is sealingly connected to the nozzle base through the first sealing ring.

9. The foldable nozzle assembly according to claim 1, wherein a second sealing ring is located at the water outlet of the rotating base, and the nozzle is sealingly connected to the rotating base through the second sealing ring.

10. A bidet, comprising a bidet body, wherein any one of the foldable nozzle assemblies according to claim 1 is mounted on the bidet body, and the nozzle assembly can be folded onto the bidet body.
